(19) United States
(12) Patent Application Publication
(10) Pub. No.: US 2025/0340022 A1
(43) Pub. Date: Nov. 6, 2025

(54) INTERMEDIATE COMPOSITE ELEMENT, PRODUCTION PROCESS AND COMPOSITE PART

(71) Applicant: HEXCEL REINFORCEMENTS, Dagneux (FR)

(72) Inventors: Pascal POULLEAU, Passins (FR); Mayeul DUCROT, Viviers Du Lac (FR); Sylvain DELALANDE, Le Bourget Du Lac (FR); Pascal PERRILLAT COLLOMB, Saint-Victor-De-Morestel (FR)

(73) Assignee: HEXCEL REINFORCEMENTS, Dagneux (FR)

(21) Appl. No.: 17/996,764

(22) PCT Filed: Apr. 21, 2021
(86) PCT No.: PCT/FR2021/050691

§ 371 Date: Mar. 7, 2023

(30) Foreign Application Priority Data
Apr. 22, 2020 (FR) FR2004026

(51) Int. Cl. B29C 70/08; B29C 70/46; B29K 63/00; B29K 101/10; B29K 105/08; B29K 307/04

(52) U.S. Cl. CPC B29C 70/085; B29C 70/46; B29K 2063/00; B29K 2101/10; B29K 2105/0881; B29K 2307/04

(57) ABSTRACT

The invention relates to an intermediate composite element (200) comprising: —at least one molded portion (300) comprising an assembly of reinforcing fibers integrated into a thermoset polymer matrix, —at least one dry stack (400) of layers of reinforcing fibers, comprising at least one polymeric porous layer inserted between two successive layers of reinforcing fibers, the molded portion (300) being affixed to the surface of the stack and bonded to the latter, characterized in that the thermoset polymer penetrates into a portion of the thickness of the dry stack (400) from the surface of the dry stack (400) on which the molded portion (300) is affixed, thereby providing the bond between the dry stack (400) and the molded portion (300). The invention also relates to a process for the production thereof, the processes for producing composite parts using such an element and the resulting composite parts.

### TECHNICAL FIELD

The present invention relates to the technical field of reinforced materials suitable for making composite parts. More specifically, the invention relates to the technical field of reinforced materials suitable for the production of composite parts combined with an injected or infused resin.

### PRIOR ART

Composite parts, comprising not only one or more fibrous reinforcements, but also a matrix (which is, typically, primarily of the thermosetting type and may include one or more thermoplastics), are being used increasingly, particularly in the aviation, automotive, and energy sectors, as a replacement for metal parts, because they combine lightness, mechanical properties, and corrosion resistance.

The production of composite parts or articles can be performed by means of two types of processes: so-called “indirect” processes and so-called “direct” or “Liquid Composite Molding” (LCM) processes.

An indirect process employs fibrous materials preimpregnated with a polymeric resin which are then shaped to produce the desired composite part by means of a compression molding operation. The fibrous prepreg materials comprise the desired amount of resin for the final composite part. The main production processes for compression molding are:
“Sheet Molding Compounds” (SMC) processes, wherein sheets of prepreg are positioned in the form of a stack;
“Bulk Molding Compounds” (BMC) processes, wherein cut fibers mixed with resin are combined in a compression molding operation.

The prior art proposed that chips be used, in particular rectangular-shaped chips, consisting of an assembly of impregnated unidirectional fibers, which can either be directly positioned randomly in a mold, or can be used to intermediately form sheet materials wherein the chips are randomly arranged extending substantially into the plane of the sheet. The intermediate sheet material thereby obtained is cut to the size of the mold, stacked in the mold, and then compression molded. These types of materials are able to flow during molding operations and fill all the portions of the mold used. Hexcel Corporation (Stamford USA) provides sheet materials of this type, marketed under the name HexMC®.

While such compression molding processes are particularly suitable for the production of three-dimensional parts having complex shapes, they nevertheless have limitations for the production of large parts.

A direct process is defined in that one or more fibrous reinforcements are employed in the “dry” state (that is, without the final matrix), with the resin to be used as a matrix being prepared separately, for example, by injection into the mold containing the fibrous reinforcements (Resin Transfer Molding (RTM) process), by infusion through the thickness of the fibrous reinforcements (Liquid Resin Infusion (LRI) process or Resin Film Infusion (RFI) process), or even by manual coating/impregnation by roller or brush, on each of the single layers of fibrous reinforcements, applied successively to the form.

For the RTM, LRI, or RFI processes, it is generally necessary to first produce a fibrous preform or stack in the form of the desired finished article, and to then impregnate this preform or stack with a resin so as to form the matrix. The resin is injected or infused by pressure differentials at temperature, and then, after the entirety of the required amount of resin is contained in the preform, the assembly is brought to a higher temperature to complete the polymerization/cross-linking cycle and thereby result in its curing.

Examples of materials suitable for direct processes include fibrous reinforcements wherein a unidirectional sheet of reinforcing fibers, particularly carbon, is combined with two veils of thermoplastic fibers, bonded to both sides of the unidirectional sheet. Such materials are described notably in applications EP 1,125,728, U.S. Pat. No. 6,828,016, WO 00/58083, WO 2007/015706, WO 2006/121961, U.S. Pat. No. 6,503,856, US 2008/7435693, WO 2010/046609, WO 2010/061114, EP 2,547,816, US 2008/0289743, US 2007/8361262, US 2011/9371604, and WO 2011/048340.

Multiaxial reinforcements, commonly referred to as “non-crimp fabrics” (NCF), are also ideally suited for direct processes. Such multiaxial reinforcements consist of a stack of several unidirectional layers of reinforcing fibers (in particular, carbon, glass, or aramid) arranged in several orientations and sewn together are particularly described in applications EP 2 547 816 and WO 2010/067003.

Direct and indirect processes therefore employ various materials, devices, and processes.

Various processes or devices are proposed in the prior art, in particular for the production of three-dimensional parts having more or less complex shapes.

Application WO 2016/207309 proposes a prepreg molding process using at least one blank of molding material which includes a guide, that, during molding, directs the flow of the molding material to be molded into the cavity of the compression mold, so that a complex shape with surface ribs can be obtained. The reinforcing fiber material is of the HexMC® or prepreg type. HexMC® materials, consisting of chips of unidirectional tape impregnated with thermosetting resin, configured in a quasi-isotropic arrangement to form a layer of fibrous material, can be easily thermoformed into a three-dimensional arrangement.

Application WO 2017/029121 describes an alternative solution consisting of a mold for producing composite parts by compression molding, comprising an inner insert having walls that can be independently moved to increase or decrease the dimensions of the insert.

It has also been proposed that various materials or intermediate elements be combined to produce particular parts, in particular, where these parts have portions of various shapes or complexity, or even portions that are subjected to various stresses.

In particular, in the prior art it has been proposed that two molded parts be bonded together by gluing or riveting, which can cause brittleness at the interface and requires additional assembly steps. In particular, a molded composite part forming a rib or projection can be attached, using such a technique, to another molded composite part.

Nevertheless, simple gluing is generally considered insufficient, particularly for aviation parts, and should be supplemented by a mechanical bond, such as riveting (see in particular the US Department of Transportation Federal Aviation Administration Advisory Circular 20-107 dated 9 Aug. 2009 and Article 14 CFR § 23.573(a)), which requires the use of suitable tooling and an additional bonding step.

Application WO 2014/168701, however, proposes to produce multi-component structures from various materials: a moldable component having a complex geometry composed of chips of unidirectional tape preimpregnated with HexMC®-type thermosetting resin, and a structural component composed of unidirectional fibers preimpregnated with thermosetting resin, which are combined and then molded in a single step by curing the thermosetting resin. Microcracking at the interface between the two components during high-temperature molding is minimized by selecting the coefficient of thermal expansion of the structural component and of the moldable component. For this reason, it is proposed that continuous fibers oriented in various directions be integrated into the structural component. Each of the components comprises 25% to 45% by weight of thermosetting resin.

Other documents propose processes suitable for the production of very specific parts: document US 2019/338881 describes a tubular-shaped fastener for the rehabilitation of pipelines with a liner that comprises a first part composed of reinforcing fibers and a resin composition that is substantially fully cured and a second part into which the resin composition penetrates, this second part consisting of dry fibers, in particular a felt. Document DE 102014009446, on the other hand, describes an attachment element which comprises a thermoplastic molded part, into which, a fiber layer 11 is inserted. This fiber layer has two parts: a part fully embedded in the molded part and two dry parts 11.1 not impregnated with thermoplastic that extend outside the molded part. Then, a composite part comprising this attachment point is obtained by impregnating the dry part with a thermosetting resin.

In this context, the present invention proposes new intermediate composite elements, processes for the production thereof, and implementation in processes for the production of composite parts, which provide more options for adaptation, according to the direct or indirect devices available at certain sites and which are more suitable for the production of parts of various shapes and dimensions. In particular, the invention is ideally suited to the production of composite parts having complex shapes, such as parts that include ribs or protrusions. The processes according to the invention can be adapted easily to various types of composite parts and can yield composite parts that have good resistance to mechanical stress. In particular, the invention proposes an intermediate composite element and a process that uses various portions necessary to make a composite part, including said intermediate composite element, and then to assemble them with a satisfactory connection at the junction between the two portions.

### Disclosures

First, the present invention relates to an intermediate composite element comprising:
at least one molded portion comprising an assembly of reinforcing fibers embedded in a thermoset polymer matrix;
at least one dry stack of layers of reinforcing fibers, in particular comprising at least one porous polymeric layer inserted between two successive layers of reinforcing fibers, the molded portion being affixed to the surface of the dry stack and bonded thereto, characterized in that the thermoset polymer partially penetrates the thickness of the dry stack from the surface of the dry stack to which the molded portion is affixed, thereby forming a bond between the dry stack and the molded part.

In the context of the invention, the thermoset polymer that forms the polymer matrix of the molded portion also penetrates the thickness of the dry stack. This penetration allows a strong bond to be formed between the molded portion and the dry stack. Therefore, it is unnecessary to supplement this bond with an additional mechanical bond. Also, advantageously, in the context of the invention, the bond between the molded portion and the dry stack is not provided by a mechanical fastening device, such as a rivet, a screw, or the like. Moreover, such an intermediate composite element is ideally suited to the production of a complex composite part, in combination with an injected or infused resin which in particular penetrates into the dry stack, by means of direct processes. In fact, as the thermoset polymer only partially penetrates into the thickness of the stack, it is necessary to supplement this dry stack by adding a polymer matrix, subsequently during the production of a composite part. In particular, the dry stack comprises from 4 to 20 layers of reinforcing fibers, preferably from 8 to 16 layers of reinforcing fibers, and at least 2, preferably at least 4 layers of reinforcing fibers of the dry stack do not contain any thermoset polymer that has penetrated from the molded part. These layers are located on the external portion of the stack opposite the surface connected to the molded part.

Advantageously, in the intermediate composite element, the dry stack of layers of reinforcing fibers has an average thickness of at least 5 mm and the thermoset polymer partially penetrates the thickness of the stack from the surface of the stack with an average penetration depth of at least 2 mm. With such penetration, irrespective of the thickness of the dry stack, the bond between the dry stack and the molded portion is satisfactory and makes it possible to obtain good shear resistance properties at the interface in the final composite part obtained from the intermediate composite element. In the context of the invention, the average thickness of the stack and the average penetration depth can be measured by taking 10 measurements perpendicular to the plane of the interface between the molded portion and the dry stack, and then calculating the arithmetic mean of these measurements. Such measurements can be made by cutting the intermediate composite element, as described in the Examples. Another way to characterize the penetration of the thermoset polymer is to observe the number of layers of reinforcing fibers of the dry stack into which the thermoset polymer has penetrated, as described above.

In the context of the invention, the dry stack is referred to as “dry” because it comprises a polymeric portion representing at most 10% of the total weight of the stack, preferably from 0.5% to 10% of the total weight of the stack, and more preferably from 2% to 6% of the total weight of the stack, said polymeric portion contributing at least partially to the cohesion of the stack. This polymeric portion does not include the amount of thermoset polymer that has penetrated the dry stack.

This polymeric portion may, in particular, be a thermoplastic polymer, a polymer comprising a thermoplastic portion, or a mixture of such polymers.

The intermediate composite element according to the invention has a unitary and cohesive character. Thus, not only are the molded portion and the dry stack bonded to each other, but the dry stack also forms a portion that is secured, that is, the layers of reinforcing fibers (also called fibrous layers) of the dry stack are bonded to each other. Such bonding can be achieved either by mechanical bonds such as sewing or knitting or by the polymeric portion contained in the dry stack, as described below.

According to one embodiment, the layers of reinforcing fibers are fabrics.

According to preferred embodiments, layers of reinforcing fibers are unidirectional sheets of reinforcing fibers, preferably oriented in at least two different directions.

According to one embodiment, the dry stack is formed from one or more non-crimp fabrics (NCFs), each NCF being an assembly of a plurality of unidirectional sheets of reinforcing fibers oriented in at least two different directions bonded by sewing or knitting. In this case, the dry stack may be formed from one or more NCFs, each NCF being an assembly of several unidirectional sheets of reinforcing fibers oriented in at least two different directions, one or more porous polymeric layer(s) may be present on the surface or between the unidirectional layers, said assembly being bonded by sewing or knitting.

When the fibrous layers are fabrics or, preferably, unidirectional sheets of reinforcing fibers, irrespective of these being in the form of NCF, at least one porous polymeric layer is inserted between two successive fabrics or two successive unidirectional sheets of reinforcing fibers. This makes it possible to optimize the mechanical properties of the composite part that is then obtained.

In particular, the porous polymeric layer(s) present within the dry stack, whatever the method of implementing the invention, is(are) a porous film, a grid, a powder coating, a fabric or, preferably, a non-woven or a veil.

With the use of such porous polymeric layer(s), the dry stack may have cohesive properties, at least in part, as a result of the hot tack properties of the porous polymeric layer(s) present between two fibrous layers.

In general, the reinforcing fibers of the dry stack and/or the molded portion are glass, carbon, aramid, or ceramic fibers, carbon fibers being particularly preferred.

According to a preferred embodiment particularly suitable for the production of complex molded parts, the molded portion is obtained by molding chips of unidirectional fibers impregnated with a thermosetting resin, which preferably forms an intermediate mat in which the chips are arranged randomly. In particular, these chips are rectangular or substantially rectangular and preferably have a length from 1 cm to 10 cm, a width from 2 mm to 2 cm and a thickness from 0.02 mm to 0.50 mm.

In the context of the invention, “complex part” and therefore, in particular, “complex molded part” means in particular that parts having at least one non-developable surface, a developable surface corresponding to a regulated surface, that is, its tangent plane is the same along a generatrix. Examples include parts having a non-constant thickness or a T-shaped portion, or parts that are T-shaped. Such molded parts can be obtained by conventional compression molding techniques, in particular.

In particular, in the intermediate composite elements according to the invention, the thermoset polymer of the molded portion is an epoxy.

In general, the thermoset polymer constitutes at least 25% by weight of the molded part, preferably 25% to 55% by weight of the molded part.

Advantageously, in the intermediate composite elements according to the invention, the dry stack comprises 4 to 20 layers of reinforcing fibers, preferably 8 to 16 layers of reinforcing fibers.

According to certain embodiments of the invention, the molded portion has a complex shape as compared to the shape of the stack. In particular, the molded portion has the shape of a hinge, a point of attachment, a rib, a ribbed beam, a support, a bracket, a channel, a bracket, a clevis, a stiffener, a hatch frame, a door frame, a lever arm, a base, a fitting, a joint, a socket, or a pivot.

Another feature of the invention relates to a process for the production of an intermediate composite element comprising:
at least one molded portion comprising an assembly of reinforcing fibers embedded in a thermoset polymer matrix,
at least one dry stack of layers of reinforcing fibers, in particular, comprising, in particular, at least one porous polymeric layer inserted between two successive layers of reinforcing fibers the molded portion being affixed to the surface of the stack and bonded thereto, said production process comprising the following successive steps:
a— affixing at least one assembly of reinforcing fibers preimpregnated with a thermosetting polymer, on a surface region of an initial dry stack of reinforcing fiber plies, comprising, in particular, at least one porous polymeric layer inserted between two successive layers of reinforcing fibers, comprising, in particular, at least one porous polymeric layer inserted between two successive layers of reinforcing fibers;
b— performing, in a mold, a hot compression molding operation of the assembly of reinforcing fibers preimpregnated with the thermosetting polymer, deposited on the initial dry stack of reinforcing fiber plies, resulting in the cross-linking of the thermosetting polymer and its partial penetration into the thickness of the stack;
c— cooling, resulting in the production of a molded portion comprising the assembly of reinforcing fibers embedded in the thermoset polymer, forming a matrix, with partial penetration of the thermoset polymer into the thickness of the stack from the surface of the stack to which the molded portion is affixed, said molded portion thus being bonded, as a result of this penetration of the thermoset polymer, to the stack of layers of reinforcing fibers thereby obtained.

Such a process makes it possible to produce intermediate composite elements according to the invention, and in particular complex-shaped intermediate composite elements, by compression molding processes accompanied by heating being particularly suitable for the production of elements of complex shape. The characteristics of the production process are therefore chosen to obtain the intermediate composite elements according to the invention, and are thus adapted to the characteristics of the invention.

In this production process, it is possible for the assembly of reinforcing fibers preimpregnated with a thermosetting polymer affixed in step a to be in the form of a preform of the desired molded part.

According to one embodiment, the plies of reinforcing fibers forming the initial dry stack used in step a are reinforcing fiber fabrics which are combined on at least one side with a porous polymeric layer, the porous polymeric layer(s) present in said ply representing at most 10% of the total weight of said ply, preferably from 0.5% to 10% of the total weight of said ply, and more preferably from 2% to 6% of the total weight of said ply, and at least one porous polymeric layer being inserted between two successive fabrics.

According to preferred embodiments, the plies of reinforcing fibers forming the initial dry stack used in step a are unidirectional sheets of reinforcing fibers, combined with at least one of their sides with a porous polymeric layer, the porous polymeric layer(s) present in said ply representing at most 10% of the total weight of said ply, preferably from 0.5% to 10% of the total weight of said ply, and more preferably from 2% to 6% of the total weight of said ply, and at least one porous polymeric layer being inserted between two successive unidirectional layers of reinforcing fibers.

In such a case, particularly preferably, the plies of reinforcing fibers forming the initial dry stack used in step a may consist of a unidirectional sheet of reinforcing fibers, combined on both of its sides with a porous polymeric layer and the porous polymeric layers present on both sides of the unidirectional sheet of reinforcing fibers are identical.

The porous polymeric layer(s) present in said plies may have hot tack properties and combining the unidirectional sheet or the fabric and said at least one porous polymeric layer forming a ply obtained previously as a result of the hot tack properties of the porous polymeric layer. Such plies are conventionally employed in the prior art as a means of dry reinforcement.

It is also possible for the initial dry stack of plies of reinforcing fibers employed in step a to have cohesive properties as a result of the hot tack properties of the porous polymeric layer(s) present. Such cohesion facilitates its handling and its implementation during the production process. In this case, it is also possible for the initial dry stack of plies of reinforcing fibers employed in step a to be preformed, especially when this dry stack is not simply a flat plate.

Another variant is that the initial dry stack of plies of reinforcing fibers employed in step a is not cohesive, as its cohesion is obtained at the end of step b, as a result of the hot tack properties of the porous polymeric layer(s) present.

Advantageously, the porous polymeric layer(s) optionally present in said plies of the initial dry stack used in step a comprises or consists of a thermoplastic polymer or a polymer comprising a thermoplastic portion.

In particular, the porous polymeric layer(s) present in said plies of the initial dry stack used in step a is a porous film, a grid, a powder coating, a fabric or, preferably, a nonwoven or a veil.

According to another variant, the plies of reinforcing fibers forming the initial dry stack are unidirectional sheets of reinforcing fibers oriented in at least two different directions, bonded by sewing or knitting. In this case, the dry stack may be formed from a plurality of NCFs, each NCF being an assembly of a plurality of unidirectional sheets oriented in at least two different directions, one or more porous polymeric layer(s) may be present on the surface or between the unidirectional sheets, said assembly being bonded by sewing or knitting. Conventionally, in the field of NCF, the sewing or knitting can be performed with glass, carbon, basalt, silica or polyester yarns or yarns made of a thermoplastic polymer, in particular yarns made of a thermoplastic polymer having a titer in the range from 5 dTex to 150 dTex, and preferably in the range from 5 dTex to 30 dTex.

In the production process according to the invention, the reinforcing fiber plies of the dry stack and/or of the assembly of prepreg reinforcing fibers are, in general, glass, carbon, aramid, or ceramic fibers, carbon fibers being particularly preferred.

According to one embodiment, particularly one ideally suited to the production of complex-shaped molded elements, the reinforcing fibers preimpregnated with a thermosetting polymer forming the assembly used to form the molded portion are chips of unidirectional fibers impregnated with a thermosetting polymer, which preferably form an intermediate mat in which the chips are arranged randomly.

Advantageously, the chips are rectangular or substantially rectangular and preferably have a length from 1 cm to 10 cm, a width from 2 mm to 2 cm, and a thickness from 0.02 mm to 0.50 mm.

Preferably, the thermosetting polymer of the assembly used to form the molded portion is an epoxy. In general, the thermosetting polymer of the assembly used to form the molded portion represents at least 25% by weight of said assembly, preferably from 25% to 55% by weight of said assembly.

In the context of the invention, step b of compression molding results in the diffusion of the thermosetting polymer, which, in its final thermoset state, partially penetrates the thickness of the stack in the area of the interface with the molded part. In most cases, the resulting dry stack of layers of reinforcing fibers has an average thickness of at least 5 mm and the thermoset polymer partially penetrates the thickness of the stack from the surface of the stack to an average penetration depth of at least 2 mm. The conditions for the molding operation, in particular, pressure, temperature and time, should be adjusted by a person skilled in the art to achieve such penetration.

In general, in step a, the initial dry stack of reinforcing fiber plies comprises 4 to 20 plies, preferably 8 to 16 plies, and advantageously, after step b, at least 2, preferably at least 4 layers of reinforcing fibers of the dry stack obtained do not contain any thermoset polymer that has penetrated from the molded part.

According to particular embodiments, the dry stack used in step a has cut-outs or perforations at least in the area of the surface to which the assembly of reinforcing fibers preimpregnated with the thermosetting polymer is affixed. Such cut-outs or perforations favor adhesion of the assembly of preimpregnated reinforcing fibers to the dry stack and, ultimately, the bond between the two parts forming the final intermediate composite element obtained.

In certain embodiments, applicable irrespective of the alternative embodiment of the production process, a mold of appropriate shape is used in step b, to obtain a molded portion having a complex shape as compared to the shape of the stack.

In particular, in the context of the invention, the intermediate composite element obtained is used to form a hinge, a point of attachment, a rib, a ribbed beam, a support, a bracket, a channel, a fastener, a clevis, a stiffener, a hatch frame, a door frame, a lever arm, a base, a fitting, a joint, a socket, or a pivot.

The invention also relates to the use of an intermediate composite element according to the invention or an intermediate composite element obtained by means of the production process described in the context of the invention, for the production of a composite part, in combination with a thermosetting resin, a thermoplastic resin, or a mixture of such resins. Such processes are referred to as direct processes. The resin or mixture of resins is infused or injected into the dry stack of the intermediate composite element, said infusion or injection being followed by cooling, the use of a thermosetting resin and a mixture of thermosetting resins being preferred. When a thermosetting resin or a mixture containing a thermosetting resin is used, the infusion or the injection is performed under conditions resulting in cross-linking of the thermosetting resin.

The invention therefore also relates to the so-called direct processes for producing a composite part, using an intermediate composite element described in the context of the invention.

In such processes, the intermediate composite element is used advantageously with other dry reinforcements. According to a first preferred variant, the invention relates to a process for the production of a composite part comprising the following steps:
A1— providing an intermediate composite element according to the invention or an intermediate composite element produced by the production process according to the invention,
A2— affixing said intermediate composite element to at least a portion of the surface of a dry stack of reinforcing fiber plies, referred to as an additional dry stack, such that the dry stack of the intermediate composite element abuts the additional dry stack,
A3— infusing or injecting a thermosetting resin, a thermoplastic resin, or a mixture of such resins, both into the dry stack of the intermediate composite element and into the additional dry stack, under conditions resulting in its cross-linking in the case where a thermosetting resin is used, said infusion or injection being followed by cooling allowing the desired final composite part to be obtained.

In the context of the invention, there is a very good bond between the intermediate composite element and the additional dry stack, as this bond is of the same type and is provided by the resin which is infused/injected into both the dry stack of the intermediate composite element and the additional dry stack. This bond is provided on the entire surface of the intermediate composite element, in contact with the additional dry stack. This, in addition to the bonding obtained by the penetration of the polymer forming the molded portion into the dry stack of the intermediate composite element, results in a part which has a good bond at the interface of the various parts that form it. Therefore, it is unnecessary to supplement these bonds with an additional mechanical bond. Also, advantageously, within the context of the invention, in the final composite part, the bond between the elements of the part corresponding to the molded portion and the dry stack of the intermediate composite element, as well as that between the intermediate composite element and the additional dry stack, are not provided by a mechanical fastening member, such as a type of rivet, screw, or the like.

It is possible for the reinforcing fiber plies forming the additional dry stack to be structurally identical to those forming the dry stack of the intermediate composite element. Although such a choice favors compatibility between the additional dry stack and the intermediate composite element and may promote bonding at the interface, it is not mandatory. Indeed, the use of various types of dry reinforcements bonded by infusion/injection of resin results, generally, in very good cohesion/bonding at the interface of the two types of reinforcement.

Moreover, the process according to the invention is particularly advantageous, as it makes it possible to produce an intermediate composite element having a smaller size and a more complex shape by means of a so-called indirect technique, in particular, by compression molding, and to affix this part to an additional dry stack having a larger size, and then to implement a so-called direct process, requiring another device, for example of the vacuum bag type, to produce the final composite part.

Also, according to certain embodiments of the invention, the intermediate composite element has a complex shape, as compared to the shape of the additional dry stack. In particular, the intermediate composite element forms, in the final composite part obtained, a hinge, a point of attachment, a rib, a ribbed beam, a support, a bracket, a channel, a tie, a clevis, a stiffener, a hatch frame, a door frame, a lever arm, a base, a fitting, a joint, a socket, or a pivot.

Advantageously, the additional dry stack has at least one dimension greater than at least one dimension of the intermediate composite element, in particular at least 2 times, preferably, at least 4 times the size of at least one dimension of the intermediate composite element. In particular, the additional dry stack has an area at least 10 times the size of the area to which the intermediate composite element is affixed.

In the context of the invention, the additional dry stack used in step A2 can be preformed.

In addition, advantageously, the surface of the additional dry stack to which the intermediate composite element is affixed has one or more surface irregularities, such as ribs or protrusions, which can be obtained, in particular, by preforming the additional dry stack beforehand. In this case, the presence of the dry stack of the intermediate composite element at the interface with the additional dry stack, which has a greater deformation capacity than a molded part, allows for a less restrictive adjustment of the relative position of the intermediate composite element and the additional dry stack. A less constraining setting and therefore a more rapid engagement than in the case of direct assembly with a molded portion can be employed. The combination/assembly of these two elements is thereby facilitated.

Although not a preferred variant of the invention, it is also possible for the intermediate composite element to be used, without any additional reinforcing element, in a direct process. Therefore, the invention also relates to a process for the production of a composite part comprising the following steps:
B1— providing an intermediate composite element according to the invention or an intermediate composite element obtained by means of the process described in the context of the invention,
B2— infusing or injecting a thermosetting resin, a thermoplastic resin, or a mixture of such resins into the dry stack of the intermediate composite element, under conditions resulting in cross-linking in the case where a thermosetting resin is used, is followed by cooling to obtain the desired final composite part.

It is understood that, in the processes for the production of composite parts according to the invention, the same characteristics as those described in connection with the intermediate composite elements or processes for their production are preferably implement, in particular for the molded part, and/or the dry stacks.

A thermosetting resin, in particular an epoxy resin, is advantageously injected or infused in step A3 or B2 respectively of the processes for the production of composite parts.

Using a conventional technique well-known to a person skilled in the art, step A3 or B2, respectively, can be performed by infusion, preferably in an open mold, for example, by means of a vacuum bag infusion technique.

The invention also relates to composite parts that can be obtained by one of the processes for manufacturing composite parts described in the context of the invention.

Such parts correspond, in particular, to composite parts employed in the aviation, automotive, space, defense, industry, or energy fields. The invention is particularly adapted to the production of complex-shaped three-dimensional parts.

The invention will be better understood from the following detailed description, by referring to the appended figures. The documents cited in this description are enclosed for reference.

### BRIEF DESCRIPTION OF THE FIGURES

FIG. 1 is a schematic cross-sectional view of an intermediate composite element according to the invention.

FIG. 2 is a schematic cross-sectional view of a composite part according to the invention.

FIG. 3 is a schematic illustration of the steps involved in the production of an intermediate composite element according to the invention.

FIG. 4 is a schematic illustration of the steps involved in the production of a composite part from an intermediate composite element according to the invention, according to the first variant of the process for the production of a composite part according to the invention.

FIG. 5 is a schematic illustration of the steps involved in the production of a composite part from an intermediate composite element according to the invention, according to the second variant of the process for the production of a composite part according to the invention.

FIG. 6A shows schematically, from a perspective view, a complex-shaped intermediate composite element and an additional dry stack (only partially shown), shaped with a series of ribs.

FIG. 6B shows the same two elements with the intermediate composite element affixed to the additional dry stack before the addition of resin to form the final part.

FIG. 6C is a magnified view of a portion of the intermediate composite element showing the interface between the molded portion and the dry stack and the partial penetration, into the thickness of the dry stack, of the thermoset polymer that also forms the matrix of the molded part.

FIG. 7 shows a photograph corresponding to a partial cross-sectional view of an intermediate composite element, showing the penetration of the polymer forming the matrix of the molded portion into the dry stack.

### INTERMEDIATE COMPOSITE ELEMENT

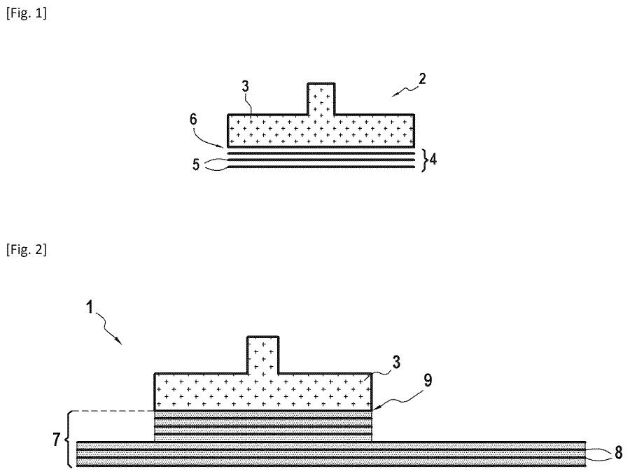

According to a first feature, the invention relates to an intermediate composite element, employed for the production of composite parts, in combination with an injected or infused resin. An intermediate composite element 2 according to the invention is illustrated schematically in FIG. 1: it comprises at least one molded portion, and in the example illustrated a single molded portion 3, and at least one dry stack, and in the example illustrated a single dry stack 4 of fibrous layers 5, the molded portion 3 and the dry stack 4 being bonded to each other. The molded portion 3 is positioned on one of the large sides of the dry fibrous stack 4, and the interface 6, corresponding to the bonded area between the molded portion 3 and the dry stack 4, may correspond to the entire surface of the side of the dry stack 4 on which the molded portion 3 is placed, as in the example shown in FIG. 1, but may also correspond to only a portion of this surface.

Molded portion 3 consists of a matrix of one or more thermoset polymer(s), in which reinforcing fibers are distributed. In the context of the invention, the term “thermoset polymer” is used to means a fully thermoset polymer or even a thermoset polymer which is not totally thermoset. In particular, it is possible that the thermoset proportion is less than 100%, but generally more than 70%. Also, in the molded part, while the thermoset polymer may contain some thermally cross-linkable functions, the polymer retains a thermoset character, that is, it cannot revert to its original liquid or paste form, even when subjected to heating.

The thermoset polymer matrix is obtained by polymerizing/cross-linking a thermoset polymer or a mixture of thermoset polymers. This molded portion is obtained by compression molding an assembly of reinforcing fibers preimpregnated with a thermosetting polymer or a mixture of thermosetting polymers. Reinforcing fibers are, conventionally, glass, carbon, aramid, or ceramic fibers, carbon fibers being particularly preferred. Reinforcing fibers can be found in any type of arrangement that is well-known to a person skilled in the art and used for the production of molded composite parts. They can be woven, non-woven, unidirectional sheets of fibers, or preferably cut fibers or chips made of unidirectional fibers. In particular, chips of unidirectional fibers impregnated with a thermosetting polymer can be used to make the molded part. Using such chips allows good creep and is particularly suitable for the production of complex molded parts. In particular, the molded portion can be made from rectangular or substantially rectangular chips, preferably having a length from 1 cm to 10 cm, a width from 2 mm to 2 cm and a thickness from 0.02 mm to 0.50 mm. Such chips of unidirectional fibers impregnated with a thermosetting polymer are obtained in particular by impregnating a unidirectional fiber roving which is then cut or by cutting a sheet impregnated with unidirectional fibers. Such chips can then be laid flat at random and pressed into a sheet to form an intermediate mat. Such intermediate mats prepared from chips of impregnated unidirectional fibers correspond, for example, to the HexMC® materials marketed by Hexcel Corporation (Stamford USA). In the case where chips consisting of unidirectional fibers are used, within the molded part, the unidirectional reinforcing fibers forming the chips are randomly oriented in three dimensions if the chips have been arranged randomly prior to the compression molding operation, or are randomly oriented predominantly in only two dimensions if the chips have been arranged as intermediate mats which are stacked and subjected to the compression molding operation.

The thermoset matrix can correspond to any type of thermosetting polymer in a thermoset state, namely epoxy, phenolic, bismaleimide, or cyanate resin, or a mixture of such resins, epoxy resins being preferred. The molded portion contains the desired amount of thermoset polymer in the final composite parts. In particular, the thermoset polymer matrix makes up at least 25% by weight of the molded part, preferably 25% to 55% by weight of the molded part.

The dry stack 4, on the other hand, consists of an assembly of layers of reinforcing fibers 5, said layers being positioned on top of each other. The dry stack 4 is cohesive, that is, the layers of reinforcing fibers 5 which constitute it are bonded together. The stack is described as “dry” because, for the production of a composite part, it should be combined with a thermoplastic or thermosetting resin, or a mixture of such resins, and in particular with a thermosetting resin. Nevertheless, the dry stack may also include a polymeric portion, but this polymeric portion represents at most 15%, preferably at most 10%, of the total weight of the dry stack, and more preferably represents from 0.5% to 10%, and preferably from 2% to 6%, of the total weight of the dry stack. This polymer portion may be a thermosetting polymer, in particular an epoxy, a thermoplastic polymer, a polymer comprising a thermoplastic portion or a mixture of such polymers. The polymeric portion is in particular in the form of one or more porous layers inserted between two layers of reinforcing fibers 5. It may also comprise one or more porous layers positioned on the surface of the dry stack 4 and/or the sewing or knitting yarns. Advantageously, the dry stack 4 contains a polymeric portion which makes it possible to ensure the cohesion of the layers of reinforcing fibers 5 and gives the dry stack 4 its unitary character.

The fibrous layers 5 of dry stack 4 can be any type of reinforcing fiber layer suitable for the production of composite parts by means of a direct process, in particular fabrics, non-wovens, or unidirectional sheets. Preferably, the layers of reinforcing fibers 5 forming the dry stack 4 are all reinforcing fiber fabrics, or even more preferably, are all unidirectional layers of reinforcing fibers.

Within the dry stack 4, the fibrous layers 5 may be varied or, preferably, are all identical. Here again, the reinforcing fibers of the fibrous layers 5 are, conventionally, glass, carbon, aramid, or ceramic fibers, with carbon fibers being particularly preferred. In the context of the invention, the dry stack 4 comprises one or more porous polymeric layers which are inserted between the layers of reinforcing fibers 5, in particular to ensure the cohesion of the stack as a result of the hot tack properties of said polymer. It is also possible for the cohesion of the stack to be ensured or partially ensured by sewing or knitting yarns, which join together the various fibrous layers of the stack or at least some of them.

“Porous layer” means a permeable layer that allows the passage of a liquid such as a resin that is injected or infused through the stack containing it when a composite part is formed. In particular, the openness factor of such a layer determined according to the process described in application WO 2011/086266, is in the range from 1% to 70%, preferably in the range from 30% to 60%. Among examples of porous layers there are porous films, grids made by interlacing yarns, powder-coated layers, fabrics, and nonwovens. The porous layer is called polymeric because it is composed of a polymer or mixture of polymers. In particular, the porous polymeric layer may be made of one or more thermoplastic polymers, one or more thermosetting polymers, or a mixture of thermosetting polymers or thermoplastic polymers. As an example of thermoplastic polymers conventionally used in a dry stack (and therefore for the forming of the porous layer(s) present), include those selected from among: polyamides (for example, PA: PA6, PA12, PA11, PA6.6, PA 6.10, PA 6.12), copolyamides (CoPA), polyamides—ether or ester block (PEBAX, PEBA), polyphthalamides (PPA), polyesters (polyethylene terephthalate (for example, PET), polybutylene terephthalate (for example, PBT), copolyesters (CoPE), thermoplastic polyurethanes (TPU), polyacetals (for example, POM), polyolefins (for example, PP, HDPE, LDPE, LLDPE), polyethersulfones (PES), polysulfones (for example, PSU), polyphenylene sulfones (for example, PPSU), polyetherether ketones (PEEK), polyether ketone ketones (PEKK), polyphenylene sulfide (PPS), polyetherimides (PEI), thermoplastic polyimides, Liquid Crystal Polymers (LCP), phenoxys, block copolymers such as styrene-butadiene-methylmethacrylate(SBM) copolymers, methyl methacrylate-butyl ethacrylate (MAM) copolymers, and mixtures thereof. It is also possible for the porous polymeric layer to be composed of or contain a partially cross-linked thermoplastic polymer, as described in application WO 2019/102136. The choice of the constituent polymer(s) of the polymeric portion of the dry stack can be modified by a person skilled in the art, based on the choice of the resin to be injected or infused, during the subsequent production of the composite parts. Advantageously, the polymeric portion of the dry stack (and therefore the porous polymeric layer(s) present therein) comprises or consists of a thermoplastic polymer or a polymer comprising a thermoplastic portion or a mixture of such polymers.

To form the intermediate composite element 2, the molded portion 3 and the dry stack 4 are bonded together. At the interface 6 between the molded portion 3 and the dry stack 4, the bond is formed by the thermoset matrix that penetrates the dry stack 4. The polymeric portion present in the dry stack, which may also be present at the interface 6, may also contribute to the formation of this bond.

In the context of the invention, the bond between the molded portion 3 and the dry stack 4 is strengthened by the partial penetration of the thermoset matrix into the thickness of the stack from the surface 6 of the stack to which the molded portion is affixed, thereby strengthening the bond between the stack and the molded part. This penetration takes place during the production of the intermediate composite element 2, as explained below.

Advantageously, in the intermediate composite element, the dry stack 4 comprises at least two layers of reinforcing fibers 5 and the thermoset polymer penetrates at least two layers of reinforcing fibers 5 of the dry stack 4. In particular, the dry stack 4 comprises from 4 to 20 layers of reinforcing fibers 5, preferably from 8 to 16 layers reinforcing fiber 5 and the thermoset polymer penetrates at least two layers of reinforcing fibers 5 of the dry stack 4, preferably at least 4 layers of reinforcing fibers 5 of the dry stack 4.

### Process for the Production of the Intermediate Composite Element

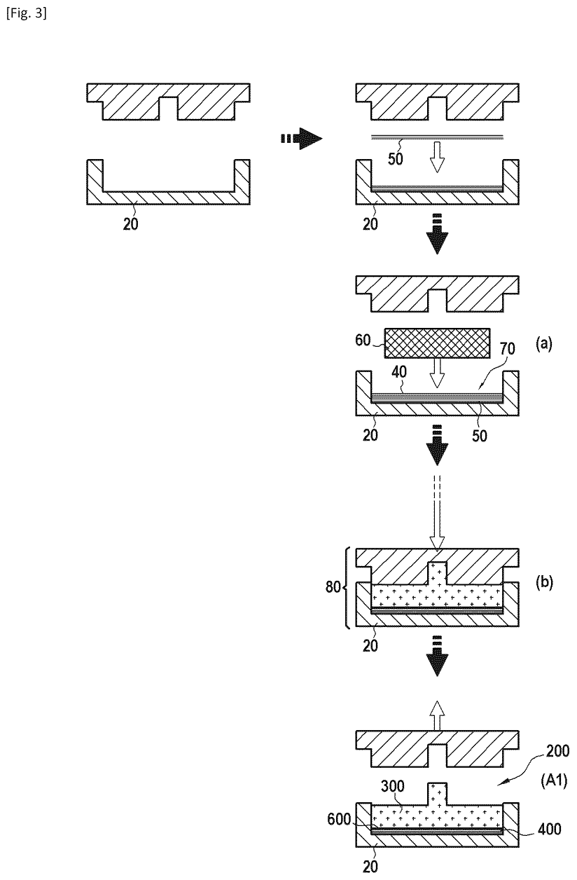

A process for the production of an intermediate composite element according to the invention is illustrated in FIG. 3 and comprises the following successive steps:
a— affixing at least one assembly 60 of reinforcing fibers preimpregnated with a thermosetting polymer, on a surface region 70 of an initial dry stack 40 of reinforcing fiber plies 50,
b— performing, in a mold 80, a hot compression molding operation of the assembly 60 of reinforcing fibers preimpregnated with the thermosetting polymer, deposited on the dry stack 40 of reinforcing fiber plies, resulting in the cross-linking of the thermosetting polymer and its partial penetration into the thickness of the stack,
c— cooling, resulting in the production of a molded portion 300 comprising the assembly of reinforcing fibers embedded in a matrix, corresponding to the thermoset polymer after thermosetting, said molded portion then also being bonded, by means of the penetrated thermoset polymer, to the stack 400 of layers of reinforcing fibers thus obtained.

The molding operation can be performed using any conventional technique well-known to a person skilled in the art. The various elements include: an assembly 60 of reinforcing fibers impregnated with a thermosetting polymer and an initial dry stack 40 of reinforcing fiber plies 50 are all subjected to the compression molding operation, as shown in FIG. 3.

To this end, the individual elements are conventionally positioned in an open mold 20 or a portion of an open mold. It is possible for the initial dry stack 40 of reinforcing fiber plies 50 to be formed directly in the mold by depositing individual plies or for the initial dry stack 40 to be formed beforehand and deposited in the mold in a single operation.

Similarly, the assembly 60 of reinforcing fibers preimpregnated with a thermosetting polymer either can be directly formed in the mold by depositing selected prepregs on the initial dry stack 40 or the assembly 60 of reinforcing fibers preimpregnated with a thermosetting polymer can be formed beforehand in the form of a preform and deposited in a single operation on the initial dry stack 40, already present in the mold 20.

For example, the assembly 60 of prepreg reinforcing fibers can correspond to a prepreg assembly of long fibers, short fibers, or staple fibers, including a stack of prepreg materials in the form of sheet of reinforcing fibers prepreg materials, in particular in the form of prepreg fabrics or prepreg unidirectional sheets, BMC (Bulk Molding Compound), or SMC (Sheet Molding Compound). In particular, prepreg fabrics and prepreg unidirectional sheets in the HexPly® range are available from Hexcel Corporation (Stamford USA).

Advantageously, the thermosetting polymer assembly 60 of prepreg reinforcing fibers can be produced from rectangular or substantially rectangular chips, preferably having a length from 1 cm to 10 cm, a width from 2 mm to 2 cm, and a thickness from 0.02 mm to 0.50 mm. Such chips of unidirectional fibers impregnated with a thermosetting polymer are obtained in particular by impregnating a unidirectional fiber roving which is then cut or by cutting a sheet impregnated with unidirectional fibers. Such chips can then be randomly laid flat and pressed into a sheet to form an intermediate mat. Such intermediate mats prepared from chips of impregnated unidirectional fibers correspond, for example, to the HexMc® materials marketed by Hexcel Corporation (Stamford USA). In the case where chips consisting of unidirectional fibers are employed, within the molded part, the unidirectional reinforcing fibers forming the chips are oriented randomly in three dimensions if the chips have been arranged randomly prior to the compression molding operation, or are oriented randomly predominantly in only two dimensions if the chips have been arranged as intermediate mats which are stacked and subjected to the compression molding operation. Thermocompression conditions and firing cycles suitable for this type of material are, for example, described in application WO 2016/207309, which can be referred to for further details.

“Fiber-reinforced plies” means a material consisting of one or more layers, said material having a unitary or cohesive character, that is, the various layers are bonded together. Within a fiber-reinforced ply 50, at least one layer of reinforcing fibers is present. Such a layer of reinforcing fibers may be in the form of a fabric, a unidirectional sheet, or a non-woven made of reinforcing fibers. According to preferred embodiments, each ply comprises a unidirectional sheet of reinforcing fibers and these various unidirectional sheets of reinforcing fibers are oriented in different directions, in the dry stack 40, as is conventional in the field.

It is also possible to use plies in which the reinforcing fiber layer is a fabric.

The dry stack 40 will correspond in the intermediate composite element 2 to the dry stack 4 and can therefore be considered a precursor stack of the latter. Thus, the initial dry stack 40 of fibrous reinforcement plies 50, includes at least one porous polymeric layer inserted between two layers of reinforcing fibers.

Reinforcing fibers are, in particular, glass, carbon, aramid, or ceramic fibers, with carbon fibers being particularly preferred. A fiber-reinforced ply 50 may also contain a polymeric portion, but in small amounts to maintain the dry properties of the initial dry stack 40. In particular, if a fiber-reinforced ply has a polymeric portion, the polymeric portion represents at most 15%, preferably at most 10% of the total weight of the fiber-reinforced ply, and preferably represents from 0.5% to 10%, and more preferably from 2% to 6% of the total weight of the fiber-reinforced ply. In this case, the fibrous reinforcement ply may, in particular, comprise a layer of reinforcing fibers and a porous polymeric layer that are integral (associated) with each other. If a polymeric portion is bonded to the fiber reinforcement, it is considered to be a part of the fiber-reinforced ply. If a polymeric portion is not bonded to the fiber-reinforced ply, while it is definitely a part of the initial dry stack 40, it is also considered to have been deposited on a fiber-reinforced ply or inserted between two fiber reinforcement plies. Thus, the dry stack 40 comprises either at least one porous polymeric layer inserted between two successive plies 50 or at least one porous polymeric layer, belonging to one ply 50 and is positioned in contact with another ply 50, in the dry stack 40. In the end, however, the initial dry stack 40 comprises a polymeric portion, which represents at most 15%, preferably at most 10% of the total weight of the fiber-reinforced ply, and preferably represents from 0.5% to 10%, and more preferably from 2% to 6% of its total weight.

According to a first alternative embodiment, the reinforcing fiber plies 50 forming the initial dry stack 40 are fibrous reinforcements, in particular unidirectional sheets of reinforcing fibers, combined on at least one of their sides with a porous polymeric layer, the porous polymeric layer or layers present in said ply representing at most 10% of the total weight of said ply, preferably from 0.5% to 10% of the total weight of said ply, and more preferably from 2% to 6% of the total weight of said ply, with at least one porous polymeric layer that is inserted between two successive fibrous reinforcements, and in particular two successive unidirectional sheets of reinforcing fibers.

It is also possible for the reinforcing fiber plies 50 forming the initial dry stack 40 to be reinforcing fiber fabrics, combined on at least one of their sides with a porous polymeric layer, the porous polymeric layer or layers present in said ply representing at most 10% of the total weight of said ply, preferably from 0.5% to 10% of the total weight of said ply, and more preferably from 2% to 6% of the total weight of said ply, with at least one porous polymeric layer that is inserted between two successive fabrics.

“Fibrous reinforcement combined on at least one of its sides with a porous layer” means that the fibrous reinforcement is bonded to at least one porous layer which is affixed to one of its sides. Such a bond is, in particular, made by gluing, in particular as a result of the hot tack properties of the porous polymeric layer. It is also possible, particularly in the case of a stack comprising several fibrous reinforcements and several porous polymeric layers, for this bond to be supplemented or replaced by a mechanical bond of the sewing or knitting type, or by any other physical means (such as needle-bonding).

In particular, the porous polymeric layer is a non-woven. The term “non-woven” and the equivalent term “veil” conventionally means an assembly of continuous or short randomly arranged fibers. These non-wovens or veils may, for example, be produced by dry processes (“Drylaid”), wet processes (“Wetlaid”), by melting (“Spunlaid”), for example, by extrusion (“Spunbond”), by extrusion blow-molding (“Meltblown”), by melt spraying (“fiberized spray applicator”), or by solvent spinning (“electrospinning,” “Flashspinning,” “Forcespinning”), well-known to the person skilled in the art. In particular, the fibers forming the non-woven have average diameters in the range from 0.5 μm to 70 μm, and preferably in the range from 0.5 μm to 20 μm. Non-wovens can be formed from short fibers or preferably, continuous fibers. In the case of a short-fiber non-woven, the fibers can, for example, have a length from 1 mm to 100 mm. Non-wovens provide random and preferably isotropic coverage.

Advantageously, the nonwoven(s) present in the initial dry stack 40 have a weight per unit area in the range from 0.2 g/m² to 20 g/m². The thickness of a nonwoven in the reinforced materials according to the invention can vary based on the nature of the combination with the fibrous reinforcement. Preferably, the nonwoven or each of the nonwovens present in the initial dry stack 40 has a thickness 0.5 μm to 50 μm after combining with the fibrous reinforcement, preferably 3 μm to 35 μm, when combining is achieved by application of heat and pressure, to take advantage of the hot tack properties of the nonwoven. When combining is achieved by mechanical means, such as sewing, knitting, or needle-bonding, the thickness of the nonwoven may be greater than 50 μm, particularly in the range from 50 μm to 200 μm. The characteristics of such nonwovens may be determined by means of the methods described in application WO 2010/046609.

Dry fabrics having powder or polymeric veils are available from Hexcel in the HexForce® range, and there are even G0926 powdered fabrics and 48302 veiled fabrics.

Preferably, in their capacity as plies of reinforcing fibers 50, those consisting of a unidirectional sheet of reinforcing fibers corresponding to the fibrous reinforcement are used, combined on at least one of its sides with a porous layer as provided for in the context of the invention. So as to have a symmetrical material, the fibrous reinforcement, and in particular the unidirectional sheet of reinforcing fibers, is combined on both of its sides with a porous layer as provided for within the context of the invention and the porous layers present on both sides of the unidirectional sheet of reinforcing fibers are preferably identical. In the context of the invention, the porous layer has heat adhesion characteristics and combining the fibrous reinforcement and the porous layer are advantageously achieved as a result of the hot tack properties of the porous layer, so as to form a single ply. These hot tack properties result from the polymer composing the porous layer, which preferably is a thermoplastic polymer, or a polymer comprising a thermoplastic portion or a mixture of such polymers. If the single reinforcing fiber plies 50 are stacked beforehand and combined in the form of a preform before being positioned in the mold, this adhesive property also gives a cohesive character to the dry stack thus obtained.

Such reinforcing fiber plies 50 are described in WO 2010/046609, WO 2010/061114, US 2008/7435693, US 2010/003881, EP 1125728, WO 2007/015706, WO 2006/121961 and U.S. Pat. No. 6,503,856, which can be referred to for further details. As in these documents, the constituent reinforcement yarns making up the unidirectional sheets can be non-twisted. It is also possible to use twisted reinforcement yarns for the forming of the unidirectional sheets, advantageously yarns twisted individually with a twist of 3 to 15 turns/m, preferably 6 to 12 turns/m.

In a second alternative embodiment, the reinforcing fiber plies 50 forming the initial dry stack 40 comprise several unidirectional layers of reinforcing fibers oriented in different directions and bonded by sewing or knitting. In particular, the reinforcing fiber plies 50 consist of a stack of layers of unidirectional reinforcing fibers oriented in different directions, preferably with at least one porous polymeric layer, as previously described, inserted between two unidirectional sheets of reinforcing fibers, or even on the surface of the stack. According to a first embodiment of this second variant, such a fiber-reinforced ply can be made from a stack corresponding to a sequence (CM/R)ⁿ, with CM designating a porous polymeric layer as provided for within the context of the invention, R designating a fibrous reinforcement as described in the context of the invention and n designating an integer, in particular 1, 2 or 3, with preferably all the CM layers having the same or even identical weights.

In a second embodiment of this second alternative embodiment, such a fiber-reinforced ply may be made from a stack corresponding to a (CM/R)ⁿ/CM sequence, with CM designating a porous polymeric layer as provided for in the context of the invention, R designating a fibrous reinforcement as described in the context of the invention and n designating an integer, in particular 1, 2 or 3, with preferably all the porous CM layers having the same or even identical weights, or the outer porous layers having a weight equal to half the weight of each of the inner porous polymeric layers.

In particular, in such stacks, the fibrous reinforcements R are unidirectional sheets of reinforcing fibers, and in particular carbon fibers, preferably having identical weight. Such materials are described as NCF (non-crimp fabric). Conventionally, in the NCF field, combining unidirectional layers of reinforcing fibers with each other and with the porous layer(s) present is achieved by sewing or knitting. Of course, provisions can be made to replace or even supplement this combining by sewing or knitting, by adhesion achieved as a result of the hot tack properties of the porous polymeric layer, preferably made of a thermoplastic polymer, or a polymer comprising a thermoplastic portion or a mixture of such polymers, or by any other means of the physical bonding type (such as needle-bonding).

In particular, in the case of NCF, the fiber-reinforced ply according to the invention is composed of unidirectional sheets extending in various orientations selected from the angles 0°, 30°, 45°, 60°, 90°, 120°, 135°. All the sheets or only some of them may have different orientations. As an example, the fiber-reinforced ply according to the invention may be made in the following stacks: 0°/90°, 90°/0°, 45°/135°, 135/45°, 90°/0°/90°, 0°/90°/0°, 135°/45°/135°, 45°/135°/45°, 0°/45°/90°, 90°/45°/0°, 45°/0°/90°, 90°/0°/45°, 0°/135°/90°, 90°/135°/0°, 135°/0°/90°, 90°/0°/135°, 45°/0°/135°, 135°/0°/45°, 45°/135°/0°, 0°/135°/45°, 45°/135°/90°, 90°/135°/45°, 135°/45°/0°, 0°/45°/135°, 135°/45°/90°, 90°/45°/135°, 60°/0°/120°, 120°/0°/60°, 30°/0°/150°, 150°/0°/30°, 135°/0°/45°/90°, 90°/45°/0°/135°, 45°/135°/0°/90°, 90°/0°/135°/45°, 0°/45°/135°/90°, 90°/135°/45°/90°, 90°/135°/0°/45°, 45°/0°/135°/90°, the 0° corresponding to the direction of advance of the machine for producing the reinforcing material according to the invention. In the case of a combination implemented by sewing or knitting, the general direction of the sewing or knitting yarns also generally corresponds to 0°. The production of such multiaxials is well-known and uses conventional techniques for example as described in the book “Textile Structural Composites, Composite Materials Series Volume 3” by Tsu Wei Chou & Franck K. Ko, ISBN 0-444-42992-1, Elsevier Science Publishers B.V., 1989, Chapter 5, paragraph 3.3 or in patent FR2761380 which describes a process and a device for the production of multiaxial fibrous sheets. In particular, unidirectional sheets can be formed before, or applied in-line, at the time the multiaxial is formed. The sewing or knitting bond between the individual unidirectional sheets can be made by means of sewing or knitting stitches extending in lines parallel to each other. In particular, the sewing or knitting stitches are spaced within the same line at a pitch, preferably identical, from 1 mm to 20 mm, preferably from 2 mm to 12 mm. Similarly, two consecutive sewing or knitting lines are, for example, spaced from each other by 2 mm to 50 mm, preferably 5 mm to 15 mm. Preferably, all consecutive sewing lines of a series of lines parallel to each other should be equally spaced. Among examples of the material constituting the sewing yarn particularly suitable in the context of the invention, there are glass, carbon, basalt, silica, thermoplastic yarns, in particular made of a polymer chosen from among the polyesters (PET), polypropylenes (PP), polyethylenes (PE), polyphenylene sulfides (PPS), polyethylene naphthalates (PEN), liquid crystal polymers (LCP), polyketones, polyamides, and mixtures thereof. Polyethylene terephthalate, polybutylene terephthalate, polytrimethylene terephthalate, polylactic acid and their copolymers are examples of polyesters that can be used. The yarn, for example, has a titer in the range from 5 dTex to 150 dTex, in particular less than 30 dTex, for example, determined according to EN ISO 2060. Further details on certain constructions that can be used in NCF type materials can be found in documents EP 2 547 816 or WO 2010/067003 in particular.

Examples of NCF are described in documents U.S. Pat. Nos. 8,361,262, 9,371,604, WO 2011/113751 and EP 2 491 175, which can be referred to for further details. Here again, the constituent reinforcement yarns can be non-twisted. It is also possible to use twisted reinforcement yarns for the forming of the unidirectional sheets, advantageously yarns twisted individually with a twist of 3 to 15 turns/m, preferably 6 to 12 turns/m.

Once the individual components are positioned in the mold, hot compression molding operation b is then performed using any suitable technique well-known to a person skilled in the art. The purpose of this operation is, first, to form and consolidate, after cooling, the molded portion 300. The shape obtained for the molded portion 300 corresponds to the desired shape which is its final shape in the final molded part 100. The shape of mold 80 is therefore adjusted accordingly. Compression molding is performed by applying pressure and heat. Conventionally, the temperature, pressure, thermal cycle and curing time are selected by a person skilled in the art as a function of the amount and properties of the thermosetting polymer present in the assembly 60 of prepreg reinforcing fibers. As an example, application WO 2016/207309 can be referred to for all the necessary details on the process and the thermosetting polymer that can be used. In particular, the thermosetting polymer present in the assembly of prepreg reinforcing fibers is an epoxy, phenolic, bismaleimide, or cyanate resin, or a mixture of such resins, with epoxy resins being preferred. The thermosetting resin contains a curing agent suitable for achieving cross-linking/curing. In particular, the thermosetting polymer makes up at least 25% by weight of the assembly of prepreg reinforcing fibers, preferably 25% to 55% by weight of the prepreg assembly of reinforced fibers.

Typically, compression molding is, for example, performed at a temperature in the range from 100° C. to 400° C., at a pressure in the range from 0.2 MPa to 2000 MPa, including a time period from 15 seconds to 2 hours. The choice of these parameters can be modified by a person skilled in the art, in particular according to the properties of the thermosetting polymer and its amount, the amount being a function of the size of the mold.

When the initial dry stack 40 includes a thermoplastic portion, step b of compression molding also has an effect on the thermoplastic portion. In particular, it is able to cause the melting or even cross-linking of the porous polymeric layer(s) present. Nevertheless, such a transformation will in no way hinder the subsequent diffusion of a resin by injection or infusion, which is necessary for the production of a composite part, given the small amount represented by the polymeric portion in the dry stack 400 thereby obtained.

Step b of compression molding also makes it possible, after cooling, for the bond between the dry stack 400 and the molded portion 300 to be obtained, as a result, and forming the intermediate composite element 200, as during molding, the thermosetting polymer also diffuses at the interface 600 with the dry stack 400 and hardens after cooling and thus secures the two parts at the interface. Indeed, following the application of pressure and heating, during the compression molding operation, the polymer partially penetrates the thickness of the dry stack 400. In addition, as shown in FIG. 3, in the case where the assembly 60 of prepreg reinforcing fibers comprises short fibers, including chips of unidirectional fibers, it is possible that creep of the reinforcing fibers and the polymer of the assembly 60 of prepreg reinforcing fibers may occur, and, thus, that the contact area 600 between the molded portion obtained and the dry stack is larger than the initial contact area 70 corresponding to the surface of the dry stack 40 to which the assembly 60 of prepreg reinforcing fibers was deposited. This creep also allows the assembly 60 of prepreg reinforcing fibers to conform perfectly to the internal walls of the mold 80 and to thereby obtain a molded portion 300 having a complex shape.

Cooling step c is usually performed outside the mold. However, cooling can also be performed in the mold, usually by maintaining the pressure applied to the mold.

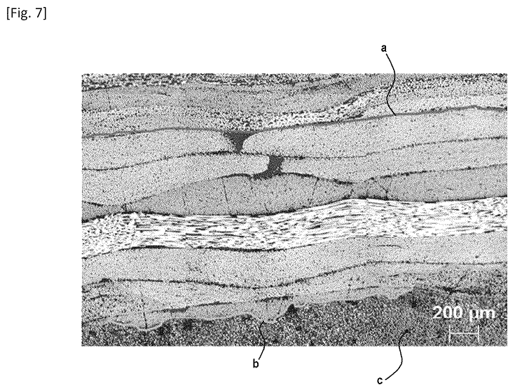

One of the advantages of the invention is that step b of compression molding also causes, from interface 600, the diffusion into the initial dry stack 40, of a portion of the thermosetting polymer present in the assembly 60 of prepreg reinforcing fibers. Thus, at the end of step b of compression molding, when the resin is in its thermoset state, the thermoset resin partially penetrates the thickness of the dry stack 400 at the interface 600 with the molded portion 300, which reinforces the bond between the dry stack 400 and the molded portion 300 obtained. In particular, such diffusion takes place over a thickness of at least 2 mm from the interface 600. In general, the initial dry stack 40 comprises from 4 to 20 reinforcing fiber plies, preferably from 8 to 16 reinforcing fiber plies 50 and the thermoset polymer penetrates at least two reinforcing fiber plies 50 of the dry stack, in particular at least 4 reinforcing fiber plies of the dry stack 400 (which includes the layers of reinforcing fibers), present in the intermediate composite element 200 obtained at the end of the molding operation. This is obvious from the photograph taken by the ZEISS Axio Imager M2m optical microscope shown in FIG. 7, which is a cross-sectional view of an intermediate reinforcing material according to the invention. Boundary line a corresponds to the interface between the molded portion (above) and the dry stack (below). An inclusion resin has been added to the dry stack so that the area of the dry stack previously impregnated with thermoset polymer can be emphasized. The photo was taken of a sample placed in a mold and then covered with inclusion resin to hold it in place. An automated polishing sequence executed by a Struers Tegramin-25 provides a flat, flawless surface for microscopic observations. Boundary line b corresponds to the inclusion resin c/region interface of the dry stack impregnated with a thermoset polymer. It can be seen that line b is well below line a, the distance between these two lines corresponding to the thickness of the dry stack into which the thermoset polymer, also present in the molded part, has penetrated. Nevertheless, reinforcing fiber plies remain in the dry stack into which the polymer from the molded portion has not penetrated. In particular, in the dry stack 400, which is present in the intermediate composite element 200, at least 2, preferably at least 4, reinforcing fiber plies contain no thermoset polymer that has penetrated from the molded part 300.

Certain modifications can be made to this process to promote the adhesion of the assembly 60 of prepreg reinforcing fibers to the dry stack and, ultimately, the bond between the two parts constituting the final intermediate composite element 200 obtained. In particular, in the area of the surface 70 to which the assembly 60 of reinforcing fibers preimpregnated with a thermosetting polymer is affixed, cut-outs or perforations can be made. By way of example, such cut-outs or perforations may have a maximum dimension of 2 mm to 150 mm.

At the end of step b, the intermediate composite element can be unmolded and transferred to another device suitable for producing a composite part by a direct process.

### Process for the Production of Composite Parts and Composite Parts

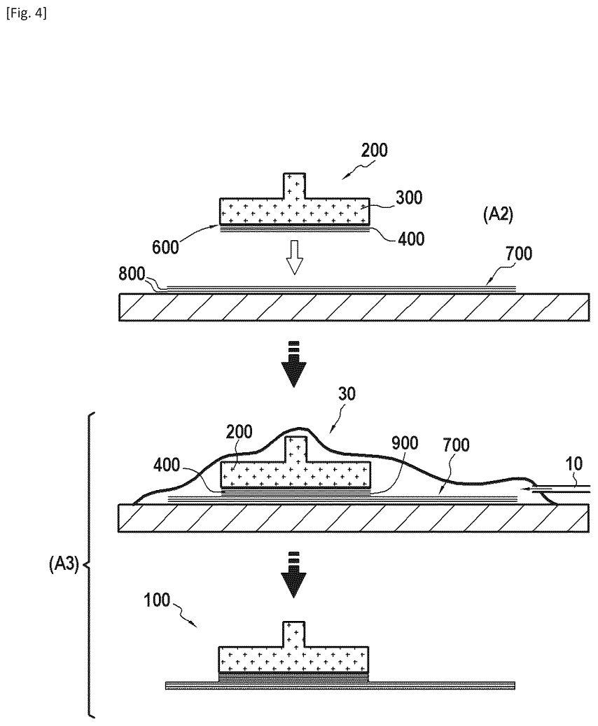

According to a first variant illustrated in FIG. 4, the invention relates to a process for the production of a composite part 100 comprising the following steps:
A1— providing an intermediate composite element 200 according to the invention or an intermediate composite element obtained according to the process for the production of an intermediate composite element described in the invention,
A2— affixing said intermediate composite element 200 to at least a portion of the surface of a dry stack of reinforcing fiber plies, known as an additional dry stack 700, so that the dry stack 400 of the intermediate composite element 200 abuts the additional dry stack 700
A3— infusing or injecting a thermosetting resin, a thermoplastic resin, or a mixture of such resins, both into the dry stack 400 of the intermediate composite element 200 and into the additional dry stack 700, said infusion or injection being followed by cooling to obtain the desired final composite part 100. In the case where the resin is a thermosetting resin or comprises a thermosetting resin, the infusion or injection is performed under conditions resulting in the cross-linking of the thermosetting resin, which is conventionally achieved by a suitable curing cycle.

In the context of the invention, the part of the dry stack 400 that is positioned on the additional dry stack 700 does not contain a thermoset polymer and therefore has a certain flexibility in conforming to the surface of the additional dry stack to which it is affixed. In step A3, the resin is then diffused into the part of the dry stack 400 that is available for such diffusion, in addition to diffusing into the additional dry stack 700. A temperature process cycle is implemented in step A3, which, after cooling, results in consolidation of the assembly and the final part 100.

Again, the additional dry stack 700 is described as “dry” because, for the production of a composite part, it should be combined with a thermoplastic or thermosetting resin, possibly mixed, in particular with a thermosetting resin. The additional dry stack 700 may therefore comprise a polymeric portion, but this polymeric portion represents at most 15%, preferably at most 10% of the total weight of the additional dry stack 700, and preferably represents from 0.5% to 10%, and more preferably from 2% to 6% of the total weight of the additional dry stack 700. The polymeric portion may in particular be in the form of one or more layers embedded in a fiber-reinforced ply, inserted between two reinforcing fiber plies and/or positioned on the surface of the additional dry stack 700, or in the form of sewing or knitting yarns. In particular, the dry stack 700 comprises either at least one porous polymeric layer inserted between two successive fibrous reinforcement plies, or a fibrous reinforcement ply including at least one polymeric porous layer positioned opposite another fibrous reinforcement ply in the dry stack 700.

The interface 900 between the intermediate composite element 200 and the additional dry stack 700 is made through the intermediary of the dry stack 400. This part of the dry stack does not include any thermoset polymer that has penetrated from the molded portion into the thickness of the dry stack which is affixed to the additional dry stack 700. Thus, at the interface 900 there is an interface between two dry materials into which the injected/infused resin is able to penetrate and to cure during step A3.

Any fiber-reinforced ply described above for the initial dry stack 40 is suitable for the additional dry stack 700. Reinforcing fiber plies 800 constituting the additional dry stack 700 may be structurally identical or structurally different from those constituting the initial dry stack 40 used to form the intermediate composite element 200. For example, it is possible to employ plies of the NCF type in the additional dry stack 700, whereas the dry stack 400 of the intermediate composite element 200 is composed of fabrics or unidirectional sheets bonded only by means of polymeric interlayers.

This first variant is particularly advantageous because it combines the advantages combined with both direct and indirect processes. A complex molded portion can be made by an indirect process and then combined with a simpler but larger part, which is then consolidated by a direct process. The intermediate bond between the dry stack 400 in the intermediate composite element 200 and the molded portion 300 provides a particularly strong bond between the two portions. In particular, one or more intermediate composite elements used to form a rib or protrusion can be affixed to the surface of an additional dry stack to form the major portion of the final composite part.

It is possible for the additional dry stack 700 of reinforcing fiber plies to be formed directly in equipment adapted to the direct process, by depositing the plies individually, or that the stack is formed beforehand and deposited in a single operation in the device into which the resin 10 is then injected or infused. In the second case, the additional dry stack 700 may be in the form of a preform adjusted to the desired shape of the final composite part 100.

The processes for ply placement and preform production are well-known a person skilled in the art.

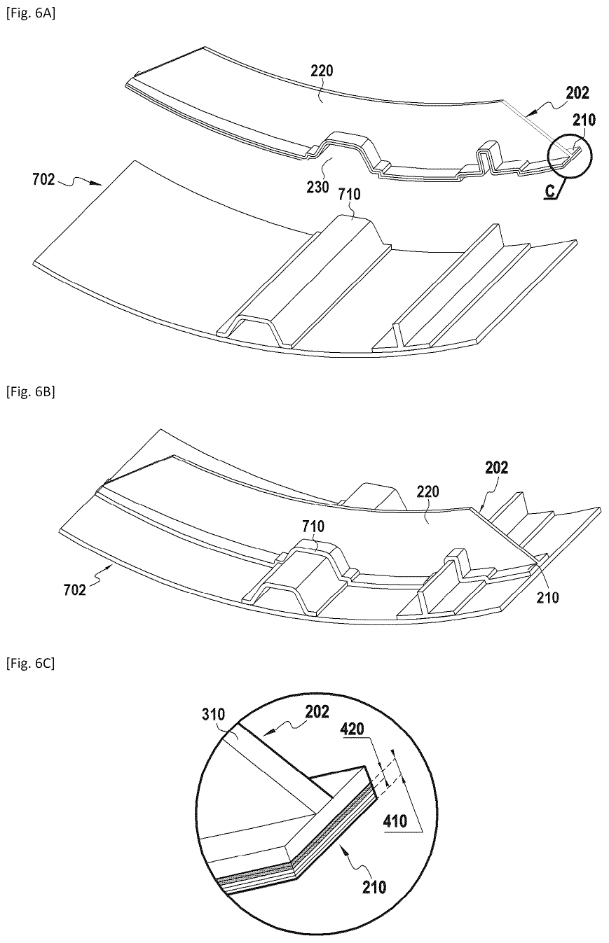

FIGS. 6A to 6B illustrate such a case. FIG. 6A shows an additional dry stack 702, or more precisely the part of this additional dry stack with the surface to which an intermediate composite element 202 is to be affixed. The additional dry stack 702 is preformed and has a series of ribs 710. As for the intermediate composite element 202, it has a complex shape, and it comprises a seat 210 and a gripping plane 220. Seat 210 also has a series of rails 230, into which the ribs 710 can be inserted. The final composite part, which is obtained after infusion/injection of resin into the assembly of the two elements affixed to each as shown in FIG. 6B, can be used, in particular, in the construction of aircraft landing gear.

FIG. 6C shows, in close-up, a portion of the intermediate composite element 202 in FIG. 6A, showing the molded portion 310 and the dry stack 410 in seat 210. In the area 420 of the dry stack 410 extending from the molded portion 310 there is penetration of the thermoset polymer that has diffused during molding and has spread out of the molded portion to partially impregnate the dry stack 410. The remainder of the stack 410 is dry and free of thermoset polymer and has greater flexibility to conform to the surface of the additional dry stack 702, which has been shaped, particularly in the area of the ribs 710.

Conventionally, in a direct process for the production of a composite part, a thermosetting resin, a thermoplastic resin, or a mixture of thermosetting resins and thermoplastic resins is injected or infused into a dry stack.

In the context of the invention, in cases where a thermoplastic portion is present in the porous polymeric layer present in the additional dry stack 700, prior to the infusion or injection of the resin, depositing or shaping as a result of the hot tack properties of the at least one porous polymeric layer present may be implemented. Advantageously, in this case, the process comprises a prior step of constituting the additional dry stack 700, with a step of depositing or shaping the reinforcing fiber plies used to form said stack, in which the porous polymeric layer is heated to a temperature that results in at least partial melting of the porous layer(s) defined in the context of the invention, and in particular to a temperature in the range from 80° C. to 130° C., preferably in the range from 80° C. to 120° C.

The deposition processes that can be used to form a stack, either directly in the equipment that will be used subsequently for the infusion or injection of the resin, or for the production of a flat preform, or even a preform in a desired three-dimensional shape, are well-known to a person skilled in the art.

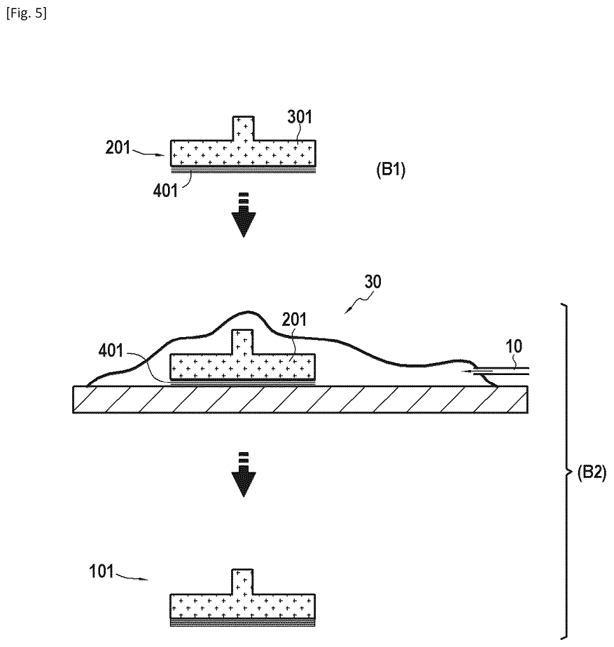

According to a second alternative embodiment illustrated in FIG. 5, although it is not preferred, the invention relates to a process for the production of a composite 101 part comprising the following steps:
B1— providing an intermediate composite part 201 according to the invention or obtained according to the process described in the context of the invention,
B2— infusing or injecting a thermosetting resin, a thermoplastic resin 10, or a mixture of such resins into the dry stack of the intermediate composite element, under conditions resulting in its cross-linking in the case where a thermosetting resin is used, followed by cooling to obtain the desired final composite part 101.

In this case, only the intermediate composite element 201, consisting of a molded portion 301 and a dry stack 401, which are bonded together by the partial penetration of the thermoset polymer, forming the polymer matrix of the molded portion 301, into the thickness of the dry stack 401, is subjected to a direct process. In the example shown, a resin 10 is injected using a device of the vacuum bag type 30. The resin is then diffused into the part of the dry stack 401 available for such diffusion.

Irrespective of the process employed for the production of a composite part, the production of the composite part by a direct process involves, as a final step, a diffusion step, by infusion or injection, of a thermosetting resin, a thermoplastic resin, or a mixture of thermosetting resins and thermoplastic resins within the dry stack(s) present, followed by a step of consolidating the desired part by a polymerization/cross-linking step according to a defined cycle of temperature under pressure, and a cooling step. According to a particular embodiment, adapted moreover to all the alternative embodiments described in terms of the invention, the diffusion, consolidation and cooling steps are performed in an open or closed mold, in particular in an open mold, for example by means of a vacuum bag infusion technique.

In particular, the diffused resin may be a thermoplastic type or preferably a thermosetting type, or may consist of a mixture of thermosetting resins and thermoplastic resins. Among examples of thermoplastic resins, there are polyamides, polyesters, polyamide-imides, polyether sulfones, polyimides, polyether ketones, polymethyl methacrylates, aromatic polyethers, and the like. Thermosetting resins which can be used are, in particular, the following, selected from among epoxides, unsaturated polyesters, vinyl esters, phenolic resins, polyimides, bismaleimides, phenol-formaldehyde resins, urea-formaldehyde resins, 1,3,5-triazine-2,4,6-triamines, benzoxazines, cyanate esters, and mixtures thereof. Such a resin may also include one or more curing agents well known to a person skilled in the art for use with the selected thermosetting polymers. Preferably, the invention is implemented with a thermosetting resin during the infusion or injection step, and in particular an epoxy resin. A mechanical bond already exists with the molded portion wherein polymer matrix has already cross-linked. However, using an injected or infused resin belonging to the same chemical family as the one present in the molded part, or even the polymeric portion present in the dry stack(s), may be preferred. This facilitates obtaining structural properties of the same type.

The invention preferably employs infusion under reduced pressure, in particular under a pressure below atmospheric pressure, in particular below 100 kPa and preferably between 10 kPa and 100 kPa, of the thermosetting resin for the production of the composite part. The infusion is preferably performed in an open mold, for example by means of a vacuum bag infusion technique.

The composite part is finally obtained after a heat treatment step. In particular, the composite part is generally obtained by a conventional consolidation cycle of the polymers involved, by performing a heat treatment, recommended by the suppliers of these polymers, and known to a person skilled in the art. This consolidation step of the desired composite part is performed by polymerization/cross-linking according to a defined cycle of temperature and pressure, followed by cooling. In the case of thermosetting resins, there is usually a gelling step before the resin is cured. The pressure applied during the process cycle is low in the case of infusion under reduced pressure and higher in the case of injection into an RTM mold.

In the context of the invention, the intermediate composite part is produced by a first compression molding process, while the final composite part is produced by resin infusion/injection. Thus, these two manufacturing steps, which require different equipment, can be performed on the same manufacturing site, and be integrated into a single production line, or can be performed at two different sites, based on the technical constraints and available resources.

The composite parts thus obtained are an integral part of the invention. FIG. 2 schematically illustrates such a composite part 1. This composite part comprises a molded portion 3, as well as a portion 7 comprising layers of reinforcing fibers 8 impregnated with a thermoplastic matrix or thermoset matrix (not shown) resulting from the implementation of a direct process.

At the interface 9 with the molded portion there is penetration of the thermoset polymer forming the molded portion. It is possible for such a part to be obtained from the intermediate composite element 2 shown in FIG. 1, according to the process described in FIG. 4, in which case some of the layers of reinforcing fibers 8 forming portion 7 correspond to the layers of reinforcing fibers 5 which formed the dry stack

The present invention is suitable for the production of a wide variety of composite parts in the aviation, automotive, space, defense, industry, or energy fields. Examples of such parts are: wing panels, fuselages, landing gear doors, movable panels, doors, wing boxes, nacelles, fuselage panels, vertical or horizontal tails, self-stiffening panels, floors, cowlings, monohull chassis, and the like

### Examples

The examples described below serve to illustrate the invention, but do not limit the scope of the invention.

Various intermediate composite elements have been produced. For the production of the molded part, either HexMC® materials or fabrics preimpregnated with a thermosetting resin, referred to as HexPly® M81, and marketed by Hexcel Corporation (Stamford USA), were used. HexMC® is a high-performance compression molding material used for the production of complex shaped parts. It is made of long carbon fibers (50 mm) and includes 38% by weight of thermosetting resin. HexPly® M81 is a 200 g/m² prepreg fabric impregnated with 42% by weight of epoxy resin.

For the production of the dry stacks, irrespective of their corresponding to those present in the intermediate composite materials or to the additional dry stacks used to produce the final composite parts, unidirectional layers of carbon fibers, IMA 12K fibers from Hexcel, combined on both of its sides with a 4 g/m² copolyamide veil-type 1R8 polymeric binder from Protechnic. Combining the unidirectional sheet and the veils was achieved as a result of the hot tack properties of the veil. The polymeric binder is combined with carbon as described in application WO 2010/046609. In the following, this unidirectional veil/unidirectional sheet combination is referred to as “dry ply” (or “ply” in Tables 1 and 2 below). Such dry plies are, in particular, described in application EP 2 342 073.

For injection molding, an epoxy resin for use on primary and secondary aviation structures, marketed by Hexcel Corporation (Stamford USA), under the reference HexFlow® RTM6 was used.

Tables 1 and 2 below summarize the various intermediate composite materials and parts according to the invention that were produced.

TABLE 1

| Intermediate | | Number of | |
|---|---|---|---|
| composite | Molded | plies in the | Orientation of the plies in |
| element | portion | dry stack | the dry stack |
| 1 | HexMC ® | 16 | [45/0/−45/90]2S |
| 2 | HexMC ® | 8 | [45/0/−45/90/45/0/−45/90] |
| 3 | HexMC ® | 4 | [45/0/−45/90] |
| 4 | HexPly ® M81 | 8 | [45/0/−45/90/45/0/−45/90] |

TABLE 2

| | Intermediate | | Number of | |
|---|---|---|---|---|
| Composite | composite | Additional | plies in the | Orientation of the |
| part | element | dry stack | dry stack | plies in the dry stack |
| I | 1 | no | — | |
| II | 2 | yes | 8 | 90/−45/0/45/90/−45/ |
| | | | | 0/45] |
| III | 3 | yes | 12 | [45/0/−45/90/ |
| | | | | 90/−45/0/45/90/−45/ |
| | | | | 0/45] |
| IV | 4 | yes | 8 | [90/−45/0/45/ |
| | | | | 90/−45/0/45] |

Three 180 mm×180 mm plies of HexMC® were cut from a 460 mm wide roll using a die-cutting press, placed in an oven at 180° C. for 10 minutes and then cooled to room temperature (22° C.). The dry 200 mm×200 mm plies and the plies of HexMC® or HexPly® were overlapped and then introduced into a mold preheated to 180° C. The interface between the prepreg assembly and the dry stack represented 80% of the upper surface of the dry stack. A press was used to close the mold and a pressure of 100 bar was applied for 20 min at 180° C. The intermediate composite element was recovered, without prior cooling of the mold. Cooling took place outside the mold.

After inclusion of the resin, a ZEISS Axio Imager M2m optical microscope was used to observe the intermediate composite elements obtained were observed with at the interface between the molded portion obtained with HexMC® and the dry stack. The images were taken of a sample of the intermediate composite elements obtained placed in a mold and then covered with inclusion resin to hold it in place. A Struers Tegramin-25 was used to execute an automated polishing sequence to obtain a flat, flawless surface for microscopic observations. These observations clearly demonstrated the penetration of the thermoset polymer provided by HexMC® into the dry stack at the interface. This penetration is visible in FIG. 7 which is a photograph taken at the interface in the case of the intermediate composite element 2 shown in Table 1. The observation in FIG. 7 shows that the penetration takes place to a depth of 2 mm, reaching 3 to 5 plies of the dry stack.

The intermediate composite element thereby obtained was placed in a mold either alone (composite part 1) or on an additional dry stack (composite part II to IV) to form the parts according to Table 2. The epoxy resin marketed by Hexcel as HexFlow RTM6 was infused at 80° C. under 1 bar into the mold equipped with a vacuum infusion system and held at a temperature of 120° C. The mold was then filled with epoxy resin and a vacuum bag infusion system was then placed in the mold. When the preform was filled and the resin came out of the mold, the outlet pipe was closed and the curing cycle started (increasing at 3° C./min to 180° C., followed by a 2 h post-curing at 180° C. and cooling to 5° C./min).

Specimens were then cut to an appropriate size for performing shear tests in the plane corresponding to the molded portion/dry stack interface in the resin matrix according to ASTM D 2344. The specimen was positioned on two support points (with a tip radius of 1.5 mm) spaced at a distance equal to 4 times the thickness of the specimen, and a punch (with a tip radius of 1.5 mm) was placed on the opposite side of the specimen at the midpoint of the two support points. Values of 41 MPa to 56 MPa were obtained, as a function of the configurations, which is entirely satisfactory. No significant difference was found in the shear strength data for Parts I and II, which demonstrates that performing the direct process with the addition of an additional dry stack has no impact on the interlaminar shear strength of the resulting part.

1-52. (canceled)

53: An intermediate composite material comprising:
(a) at least one molded portion comprising an assembly of reinforcing fibers embedded in a thermoset polymer matrix;
(b) at least one stack of layers of dry reinforcing fibers, said stack further comprising at least one layer of porous polymeric material inserted between successive layers of dry reinforcing fibers; and
(c) the moldeded portion being affixed and bonded to the surface of the dry stack by partial penetration of the thermoset polymer matrix into the stack of dry layers.

54: The intermediate composite material of claim 53, wherein the stack of dry reinforcing fibers has an average thickness of at least 5 mm and the thermoset polymer partially penetrates the thickness of the stack of dry reinforcing fibers to an average penetration depth of at least 2 mm.

55: The intermediate composite material of claim 54, wherein the stack of dry reinforcing fibers are chosen from the group consisting of: layers of fabrics; unidirectional sheets of reinforcing fibers; and layers of non-crimp fabrics (NCFs), which have been bonded together by sewing or knitting.

56: The intermediate composite material of claim 55, wherein the porous polymeric layers are chosen from the group consisting of: a porous film, a grid, a powder coating, a fabric, or, a non-woven fabric or veil.

57: The intermediate composite material of claim 56, wherein said molded portion comprises molded chips of unidirectional fibers impregnated with thermosetting resin, said chips being arranged randomly in the x-y plane, but quasi-isotopically with respect to the z direction.

58: The intermediate composite material of claim 57, wherein the stack of dry reinforcing layers comprises at least 8 to 16 layers of reinforcing fibers and at least 4 layers do not contain any thermoset polymer matrix from the molded portion.

59: A process for the production of an intermediate composite element, comprising:
(a) preparing at least one molded portion comprising an assembly of reinforcing fibers embedded in a thermoset polymeric matrix;
(b) preparing at least one stack of layers of dry reinforcing fibers, said stack further comprising at least one layer of porous polymeric material inserted between two successive layers of reinforcing fibers;
(c) affixing and bonding the molded portion to the surface of the at least one stack of layers of dry reinforcing fibers to form an assembly;
(d) subjecting the assembly to hot compression molding, whereby at least a portion of the thermoset polymeric matrix from the molded portion will penetrate at least a portion of the stack of layers of dry reinforcing fibers; and
(e) cooling the assembly.

60: The process of claim 59, wherein the porous polymeric layer between the layers of the stack of dry reinforcing fibers is chosen from the group consisting of: a porous film, a grid, a powder coating, a fabric or, a nonwoven or a veil.

61: The process of claim 60, wherein the stack of layers of dry reinforcing fibers has an average thickness of at least 5 mm and the thermoset polymer partially penetrates the thickness of the stack from the surface of the stack to an average penetration depth of at least 2 mm.
